(19) United States
(12) Patent Application Publication
(10) Pub. No.: US 2025/0382435 A1
(43) Pub. Date: Dec. 18, 2025

(54) DIENE RUBBER COMPOSITION COMPRISING A MICROSILICA

(71) Applicant: Compagnie Generale Des Etablissements Michelin, Clermont-Ferrand (FR)

(72) Inventors: Benjamin GORNARD, Clermont-Ferrand (FR); Scott WOLFS, Clermont-Ferrand (FR); José-Carlos ARAUJO DA SILVA, Clermont-Ferrand (FR)

(73) Assignee: Compagnie Generale Des Etablissements Michelin, Clermont-Ferrand (FR)

(21) Appl. No.: 18/875,914

(22) PCT Filed: Jun. 8, 2023
(86) PCT No.: PCT/EP2023/065349

§ 371 Date: Dec. 17, 2024

(30) Foreign Application Priority Data
Jun. 20, 2022 (FR) FR2206002

(51) Int. Cl. C08K 3/36; B60C 1/00; C08F 210/02; C08K 5/548

(52) U.S. Cl. CPC C08K 3/36; B60C 1/0016; C08F 210/02; C08K 5/548; C08F 2800/10; C08F 2810/20; C08K 2201/006

(57) ABSTRACT

A rubber composition which comprises a diene elastomer, a first silica which is a precipitated or pyrogenic silica and which has a BET specific surface of greater than 100 m²/g as reinforcing filler, a second silica which is a microsilica with a BET specific surface of less than 50 m²/g, a silane coupling agent and a crosslinking system is provided. The contents of the first silica and of the second silica are expressed as part by weight per hundred parts of elastomer, phr, and respectively denoted T1 and T2. T1 is greater than 15 phr and less than T2, and the sum of T1 and of T2 are greater than 75 phr. The rubber composition exhibits an increased hysteresis potential, which makes it possible to improve the wet grip performance qualities of a tread of a tire containing such a rubber composition.

### CROSS REFERENCE TO RELATED APPLICATIONS

This U.S. patent application is a national phase entry of PCT patent application No. PCT/EP2023/065349, filed Jun. 8, 2023, which claims priority to French Patent Application No. FR 2206002, filed Jun. 20, 2022, the entire contents of which are incorporated herein by reference in their entirety.

### BACKGROUND

### 1. Technical Field

The field of the present invention is that of diene rubber compositions reinforced by a silica and intended to be used in a tire, more particularly in a tread of a tire.

### 2. Related Art

A tire tread has to meet, in a known way, a large number of often conflicting technical requirements, including a low rolling resistance, a high wear resistance, a high dry grip and a high wet grip.

This compromise in properties, in particular from the viewpoint of the rolling resistance and the wear resistance, could be improved in recent years with regard to energy-saving “Green Tires”, intended in particular for passenger vehicles, by virtue in particular of the use of novel low-hysteresis rubber compositions having the characteristic of being reinforced predominantly by specific inorganic fillers, described as reinforcing fillers, in particular by highly dispersible silicas (HDSs), capable of rivalling, from the viewpoint of the reinforcing power, conventional tire-grade carbon blacks.

However, improving the grip properties, in particular the wet grip properties, remains a constant concern of tire designers. One way of giving the tire a high wet grip is to use, in its tread, a rubber composition which exhibits a broad hysteresis potential.

The highly dispersible silicas conventionally used in rubber compositions for treads are generally precipitated or pyrogenic silicas, referred to as reinforcing silicas. Reference may be made, for example, to the publication Encyclopedia of Polymer Science and Technology, John Wiley and Sons Inc., Vol. 11, p. 612 (2004).

The use of silica fume, also referred to under the name microsilica, is widespread in the concrete industry. It is used much less in tire rubber compositions and, when it is used in tire rubber compositions, it is used at contents which are much lower than those of the silica conventionally used. It has been proposed, in Patent Application JP2006241297, to replace a precipitated silica by a microsilica in a diene rubber composition reinforced by a carbon black in order to improve its processability. It has also been proposed, in the document EP 2 072 284, to add a microsilica to a rubber composition of an inner liner of a tire comprising a butyl rubber and a carbon black as reinforcing filler in order to improve the impermeability properties of the inner liner. It has also been proposed, in the document EP 2 336 231 A1, to introduce, into a diene rubber composition for a tread of a tire comprising, as reinforcing filler, a highly structured precipitated silica, a microsilica at a content which is much lower than the content of the precipitated silica in order to improve the rolling resistance performance of the tire.

### SUMMARY

The Applicant Company has discovered that the introduction, into a diene rubber composition comprising a reinforcing silica, of a microsilica at a higher content than the reinforcing silica makes it possible to increase the hysteresis potential of the rubber composition and thus to improve the wet grip performance qualities of a tread of a tire containing such a rubber composition.

Thus, a first subject-matter of the invention is a rubber composition which comprises a diene elastomer, a first silica which is a precipitated or pyrogenic silica and which has a BET specific surface of greater than 100 m²/g as reinforcing filler, a second silica which is a microsilica with a BET specific surface of less than 50 m²/g, a silane coupling agent and a crosslinking system,
in which:
the contents of the first silica and of the second silica being expressed as part by weight per hundred parts of elastomer, phr, and respectively denoted T1 and T2:
T1 is greater than 15 phr and is less than T2,
and the sum of T1 and of T2 is greater than 75 phr.

Another subject-matter of the invention is a tire which comprises a rubber composition in accordance with the invention, preferentially in its tread.

### DETAILED DESCRIPTION OF EXAMPLE EMBODIMENTS

Any interval of values denoted by the expression “between a and b” represents the range of values greater than “a” and less than “b” (that is to say, limits “a” and “b” excluded), whereas any interval of values denoted by the expression “from a to b” means the range of values extending from “a” up to “b” (that is to say, including the strict limits “a” and “b”).

Within the meaning of the present invention, the expression “part by weight per hundred parts by weight of elastomer” (or phr) should be understood as meaning the part by mass per hundred parts by mass of elastomer.

The compounds mentioned in the description may be of fossil origin or may be biobased. In the latter case, they can result, partially or completely, from biomass or be obtained, partially or completely, from renewable starting materials resulting from biomass. In the same way, the compounds mentioned can also originate from the recycling of pre-used materials, that is to say that they can, partially or completely, result from a recycling process, or else be obtained from starting materials which themselves result from a recycling process.

In the present invention, the term “tire” is understood to mean a pneumatic or non-pneumatic tire. A pneumatic tire usually comprises two beads intended to come into contact with a rim, a crown composed of at least one crown reinforcement and a tread, two sidewalls, the tire being reinforced by a carcass reinforcement anchored in the two beads. A non-pneumatic tire, for its part, usually comprises a base, designed for example for mounting on a rigid rim, a crown reinforcement, ensuring the connection with a tread, and a deformable structure, such as spokes, ribs or cells, this structure being arranged between the base and the crown. Such non-pneumatic tires do not necessarily comprise a sidewall. Non-pneumatic tires are described, for example, in the documents WO 03/018332 and FR 2 898 077. According to any one of the embodiments of the invention, the tire according to the invention is preferentially a pneumatic tire.

Microsilica, also denoted silica fume, should not be confused with fumed silica, also known as pyrogenic silica. The production process, the morphology of the particles and the fields of application of microsilica are different from those of fumed silica. Microsilica is conventionally obtained in processes for the manufacture of silicon or ferrosilicon alloys. During an electrometallurgical process implementing the carboreduction of quartz in the production of silicon and Fe—Si alloys, a by-product, a gas of formula SiO, is formed which is upgraded by oxidizing it in contact with oxygen in order to form SiO₂ which is condensed to give spherical particles of silica fume. Silica fume or microsilica is an amorphous, non-crystalline and polymorphic form of SiO₂. Microsilica consists essentially of spherical particles of nanometric size. The most important application of microsilica is the pozzolanic material for high-performance concrete.

“Diene” elastomer (or, without distinction, rubber), whether natural or synthetic, should be understood, in a known way, as meaning an elastomer composed, at least in part (i.e., a homopolymer or a copolymer), of diene monomer units (monomers bearing two conjugated or non-conjugated carbon-carbon double bonds).

The term “diene elastomer capable of being used in the compositions in accordance with the invention” is understood in particular to mean:
(a)—any homopolymer of a conjugated or non-conjugated diene monomer having from 4 to 24 carbon atoms;
(b)—any copolymer of a conjugated or non-conjugated diene having from 4 to 24 carbon atoms and of at least one other monomer.

The term “copolymer of a conjugated or non-conjugated diene having from 4 to 24 carbon atoms and of at least one other monomer” should be understood as meaning a copolymer of a diene and of one or more other monomer(s). Mention may be made, as other monomer, of ethylene, an olefin and a conjugated or non-conjugated diene other than the first diene.

Suitable as conjugated dienes are conjugated dienes having from 4 to 24 carbon atoms, in particular 1,3-dienes having from 4 to 12 carbon atoms, such as in particular 1,3-butadiene and isoprene, or also a 1,3-diene of formula CH₂═CR—CH═CH₂, in which R represents a hydrocarbon chain having from 3 to 20 carbon atoms, such as, for example, a linear monoterpene (C₁₀H₁₆), such as myrcene, a linear sesquiterpene (C₁₅H₂₄), such as farnesene, and the like. Very particularly, suitable as conjugated dienes are 1,3-butadiene, isoprene, myrcene and farnesene.

Suitable as non-conjugated dienes are non-conjugated dienes having from 6 to 12 carbon atoms, such as 1,4-hexadiene, ethylidenenorbornene or dicyclopentadiene.

Suitable as olefins are vinylaromatic compounds having from 8 to 20 carbon atoms and aliphatic α-monoolefins having from 3 to 12 carbon atoms.

Suitable as vinylaromatic compounds are, for example, styrene, ortho-, meta- or para-methylstyrene, the “vinyltoluene” commercial mixture or para-(tert-butyl) styrene.

Suitable as aliphatic α-monoolefins are in particular acyclic aliphatic α-monoolefins having from 3 to 18 carbon atoms.

### More Particularly, the Diene Elastomer is:

(a′)—any homopolymer of a conjugated diene monomer, in particular any homopolymer obtained by polymerization of a conjugated diene monomer having from 4 to 12 carbon atoms;
(b′)—any copolymer obtained by copolymerization of one or more conjugated dienes with one another or with one or more vinylaromatic compounds having from 8 to 20 carbon atoms;
(c′)—a copolymer of isobutene and of isoprene (butyl rubber) and also the halogenated versions, in particular chlorinated or brominated versions, of this type of copolymer;
(d′)—any copolymer obtained by copolymerization of one or more conjugated or non-conjugated dienes with ethylene, an α-monoolefin or their mixture, such as, for example, the elastomers obtained from ethylene, from propylene with a non-conjugated diene monomer of the abovementioned type, or also the elastomers obtained from ethylene and from one or more 1,3-dienes of the abovementioned type.

When the diene elastomer is a copolymer, it is preferentially a statistical copolymer.

The diene elastomer can be modified, for example, that is to say coupled, star-branched or functionalized. Mention may be made, among the functionalized elastomers, of those bearing one or more functional groups comprising a heteroatom, such as Si, N and O.

The diene elastomer of use for the requirements of the invention is preferentially a homopolymer of a 1,3-diene or a copolymer of a 1,3-diene or their mixture. The 1,3-diene is preferentially 1,3-butadiene or a mixture of 1,3-dienes, one of which is 1,3-butadiene. When the diene elastomer is a copolymer of a 1,3-diene, it is preferentially a statistical copolymer.

According to a first alternative form of the invention, the diene elastomer is selected from the group consisting of highly unsaturated elastomers, that is to say diene elastomers which contain at least 50 mol % of diene units. In a known way, the term “diene unit” is understood to mean a unit resulting from the polymerization of a diene and containing a carbon-carbon double bond. Mention may be made, as highly unsaturated diene elastomers, of polybutadienes (BRs), natural rubber (NR), synthetic polyisoprenes (IRs), butadiene copolymers, isoprene copolymers and the mixtures of these elastomers.

According to a second alternative form of the invention, the diene elastomer is a copolymer of ethylene and of a 1,3-diene and contains more than 50 mol % of ethylene units. Due to its predominant content of ethylene units, it is described as highly saturated elastomer. It is preferentially statistical. In a known way, the expression “ethylene unit” refers to the —(CH₂—CH₂)— unit resulting from the insertion of ethylene into the elastomer chain.

Unless otherwise indicated, the contents of the units resulting from the insertion of a monomer into a copolymer, such as the copolymer of use in the invention, are expressed as molar percentage with respect to all of the monomer units of the copolymer.

Preferably, the highly saturated diene elastomer comprises at least 55 mol % of ethylene units, preferentially at least 60 mol % of ethylene units, more preferentially at least 65 mol % of ethylene units. In other words, the ethylene units in the highly saturated diene elastomer preferentially represent at least 55 mol % of all of the monomer units of the highly saturated diene elastomer, more preferentially at least 60 mol % of all of the monomer units of the highly saturated diene elastomer. More preferentially still, the ethylene units represent at least 65 mol % of all of the monomer units of the highly saturated diene elastomer.

Preferably, the ethylene units in the highly saturated diene elastomer represent at most 90 mol % of all of the monomer units of the highly saturated diene elastomer. More preferentially, the ethylene units represent at most 85 mol % of all of the monomer units of the highly saturated diene elastomer. More preferentially still, the ethylene units represent at most 80 mol % of all of the monomer units of the highly saturated diene elastomer.

According to an advantageous embodiment, the highly saturated diene elastomer comprises from 55 mol % to 90 mol % of ethylene units, particularly from 55 mol % to 85 mol % of ethylene units, the molar percentage being calculated on the basis of all of the monomer units of the highly saturated diene elastomer. More advantageously, the highly saturated diene elastomer comprises from 55 mol % to 80 mol % of ethylene units, the molar percentage being calculated on the basis of all of the monomer units of the highly saturated diene elastomer.

According to another advantageous embodiment, the highly saturated diene elastomer comprises from 60 mol % to 90 mol % of ethylene units, particularly from 60 mol % to 85 mol % of ethylene units, the molar percentage being calculated on the basis of all of the monomer units of the highly saturated diene elastomer. More advantageously, the highly saturated diene elastomer comprises from 60 mol % to 80 mol % of ethylene units, the molar percentage being calculated on the basis of all of the monomer units of the highly saturated diene elastomer.

According to yet another advantageous embodiment, the highly saturated diene elastomer comprises from 65 mol % to 90 mol % of ethylene units, particularly from 65 mol % to 85 mol % of ethylene units, the molar percentage being calculated on the basis of all of the monomer units of the highly saturated diene elastomer. More advantageously, the highly saturated diene elastomer comprises from 65 mol % to 80 mol % of ethylene units, the molar percentage being calculated on the basis of all of the monomer units of the highly saturated diene elastomer.

As the highly saturated diene elastomer is a copolymer of ethylene and of a 1,3-diene, it also comprises 1,3-diene units resulting from the polymerization of a 1,3-diene. In a known way, the expression “1,3-diene unit” or “diene unit” refers to units resulting from the insertion of the 1,3-diene via a 1,4-addition, a 1,2-addition or a 3,4-addition in the case of isoprene, for example. Preferably, the 1,3-diene is 1,3-butadiene or a mixture of 1,3-dienes, one of which is 1,3-butadiene. More preferentially, the 1,3-diene is 1,3-butadiene, in which case the highly saturated diene elastomer is a preferably statistical copolymer of ethylene and of 1,3-butadiene.

The highly saturated diene elastomer can be obtained according to various synthesis methods known to a person skilled in the art, in particular as a function of the targeted microstructure of the highly saturated diene elastomer. Generally, it can be prepared by copolymerization at least of a 1,3-diene, preferably 1,3-butadiene, and of ethylene and according to known synthesis methods, in particular in the presence of a catalytic system comprising a metallocene complex. Mention may be made, as such, of catalytic systems based on metallocene complexes, which catalytic systems are described in the documents EP 1 092 731, WO 2004/035639, WO 2007/054223 and WO 2007/054224 in the name of the Applicant Company. The highly saturated diene elastomer, including when it is statistical, can also be prepared by a process using a catalytic system of preformed type, such as those described in the documents WO 2017/093654 A1, WO 2018/020122 A1 and WO 2018/020123 A1. Advantageously, the highly saturated diene elastomer is statistical and is preferentially prepared according to a semi-continuous or continuous process, such as described in the documents WO 2017/103543 A1, WO 2017/13544 A1, WO 2018/193193 and WO 2018/193194.

The highly saturated diene elastomer preferably contains units of formula (I) or units of formula (II).

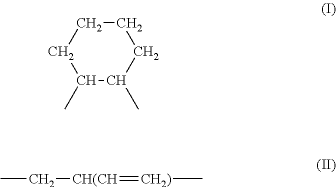

The presence of a saturated 6-membered cyclic unit, a 1,2-cyclohexane unit, of formula (I) in the copolymer can result from a series of very specific insertions of ethylene and of 1,3-butadiene into the polymer chain during its growth. When the highly saturated diene elastomer comprises units of formula (I) or units of formula (II), the molar percentages of the units of formula (I) and of the units of formula (II) in the highly saturated diene elastomer, respectively o and p, preferably satisfy the following equation (eq. 1) or the equation (eq. 2), o and p being calculated on the basis of all of the monomer units of the highly saturated diene elastomer.

$$0 < o + p \leq 30 \qquad ( eq . 1 )$$

$$0 < o + p < 25 \qquad ( eq . 2 )$$

Preferably, the highly saturated diene elastomer comprises units of formula (I) in a molar content of greater than 0 mol % and of less than 15 mol %, more preferentially of less than 10 mol %, the molar percentage being calculated on the basis of all of the monomer units of the highly saturated diene elastomer.

Preferably, the content of the highly saturated diene elastomer in the rubber composition is at least 50 parts by weight per hundred parts of elastomer of the rubber composition (phr). More preferentially, the content of the highly saturated diene elastomer in the rubber composition varies in a range extending from 80 to 100 phr. More preferentially still, it varies in a range extending from 90 to 100 phr. It is advantageously 100 phr. The highly saturated diene elastomer can be a single highly saturated diene elastomer or else a mixture of several highly saturated diene elastomers which differ from one another in their microstructures or in their macrostructures. In the case where the rubber composition contains several highly saturated diene elastomers which differ from one another in their microstructures or in their macrostructures, the content of the highly saturated diene elastomer in the rubber composition refers to the mixture of highly saturated diene elastomers.

The embodiments of the invention according to which the rubber composition comprises at least 50 phr of a highly saturated diene elastomer are particularly advantageous for the use of the rubber composition in a tread of a tire, since the tread combines both a good wet grip performance and a good wear resistance performance.

The rubber composition of the invention can contain just one diene elastomer or a mixture of several diene elastomers, whether they are or are not highly saturated. According to any one of the embodiments of the invention, the elastomers which participate in the diene rubber composition in accordance with the invention are preferentially all diene elastomers.

The rubber composition in accordance with the invention has as another essential characteristic that of comprising, as reinforcing filler, a silica having a specific surface of greater than 100 m²/g, referred to as first silica. The first silica used as reinforcing filler is a precipitated silica or a pyrogenic silica, preferably a precipitated silica.

Use may be made of any type of precipitated silica, in particular highly dispersible precipitated silicas (HDSs), provided that they exhibit a BET specific surface of greater than 100 m²/g. These precipitated silicas, which are or are not highly dispersible, are well known to a person skilled in the art. Mention may be made, for example, of the silicas described in Applications WO 03/016215-A1 and WO 03/016387-A1. Use may in particular be made, among commercial HDS silicas, of the Ultrasil® 5000GR and Ultrasil® 7000GR silicas from Evonik or the Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, the Zeosil® 175GR silica from Solvay or the Hi-Sil EZ120G(−D), Hi-Sil EZ160G(−D), Hi-Sil EZ200G(−D), Hi-Sil 243LD, Hi-Sil 210 and Hi-Sil HDP 320G silicas from PPG.

Of course, the first silica can be a mixture of silicas, in particular of precipitated silicas as are described above.

The physical state under which the first silica is provided is not important, whether this is in the form of a powder, of microbeads, of granules, or also of beads or any other appropriate densified form.

The first silica exhibits a BET specific surface preferentially of less than 200 m²/g, more preferentially of less than 180 m²/g.

In the present disclosure, the BET specific surface is determined by gas adsorption using the Brunauer-Emmett-Teller method described in “The Journal of the American Chemical Society” (Vol. 60, page 309, February 1938) and more specifically according to a method adapted from Standard NF ISO 5794-1, Appendix E, of June 2010 [multipoint (5 point) volumetric method-gas: nitrogen-degassing under vacuum: one hour at 160° C.—relative pressure p/po range: 0.05 to 0.17].

The rubber composition can additionally comprise a carbon black. Suitable as carbon blacks are all carbon blacks, in particular the blacks conventionally used in tires or their treads. Mention will more particularly be made, among the latter, of the reinforcing carbon blacks of the 100, 200 and 300 series, or the blacks of the 500, 600 or 700 series (ASTM D-1765-2017 grades), for example the N115, N134, N234, N326, N330, N339, N347, N375, N550, N683 and N772 blacks. These carbon blacks can be used in the isolated state, as commercially available, or in any other form, for example as support for some of the rubber additives used. When the carbon black is used in the rubber composition, it is preferably used at a content of less than or equal to 10 phr (for example, the carbon black content can be within a range extending from 1 to 10 phr). Advantageously, the carbon black content in the rubber composition is less than or equal to 5 phr. Within the intervals indicated, benefit is derived from the colouring properties (black pigmenting agent) and UV-stabilizing properties of the carbon blacks, without, moreover, adversely affecting the typical performance qualities contributed by the silica.

The rubber composition also has as another essential characteristic that of comprising a microsilica with a BET specific surface of less than 50 m²/g, preferentially of greater than 10 m²/g and of less than 40 m²/g, more preferentially still of greater than or equal to 15 m²/g and of less than or equal to 30 m²/g. Microsilicas are products which are commercially available, for example under the trade names “Sidistar” and “Microfume” from the respective companies Elkem and Ferropem.

The content of the first silica and the content of the second silica in the rubber composition, respectively denoted T1 and T2 and expressed in phr, are such that T1 is greater than 15 phr and is less than T2 and that the sum of T1 and of T2, that is to say T1+T2, is greater than 75 phr. Typically, the sum of T1 and of T2 is between 75 phr and 180 phr.

Preferably, the sum of T1 and of T2 is less than 140 phr. The sum of T1 and of T2 is advantageously greater than 90 phr and less than 140 phr.

According to a particularly preferential embodiment of the invention, the contents T1 and T2 are linked by the following relationship (1). This particularly preferential embodiment is advantageous for an application of the rubber composition in a tread of a tire because the rubber composition has a contribution with respect to the hysteresis in the area of the rolling resistance which is reduced while having a high hysteresis potential in the area of the wet grip performance.

$$T 2 \geq 1.73 \times ( T 1 + T 2 ) - 125 \qquad ( 1 )$$

When this particularly preferential embodiment is combined with the embodiment according to which the rubber composition contains more than 50 phr of a highly saturated diene elastomer as defined above, the rubber composition has the property of giving a tread of a tire simultaneously good grip, rolling resistance and wear resistance performance qualities.

Use is made, in a well-known way, of a coupling agent (or bonding agent), a silane, intended to provide a satisfactory connection, of chemical and/or physical nature, between the silicas of the rubber composition (surface of their particles) and the diene elastomer. Use is made in particular of organosilanes or polyorganosiloxanes which are at least bifunctional. The term “bifunctional” is understood to mean a compound having a first functional group capable of interacting with the silicas and a second functional group capable of interacting with the diene elastomer. For example, such a bifunctional compound can comprise a first functional group comprising a silicon atom, said first functional group being capable of interacting with the hydroxyl groups of a silica, for example of the first silica, and a second functional group comprising a sulfur atom, said second functional group being capable of interacting with the diene elastomer.

Use is made in particular of silane polysulfides, referred to as “symmetrical” or “unsymmetrical” depending on their specific structure, such as described, for example, in Applications WO 03/002648 (or US 2005/016651) and WO 03/002649 (or US 2005/016650).

Suitable in particular, without the definition below being limiting, are silane polysulfides corresponding to the following general formula (I):

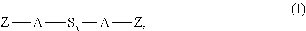

in which:
x is an integer from 2 to 8 (preferably from 2 to 5);
the A symbols, which are identical or different, represent a divalent hydrocarbon radical (preferably a C₁-C₁₈ alkylene group or a C₆-C₁₂ arylene group, more particularly a C₁-C₁₀, in particular C₁-C₄, alkylene, especially propylene);
the Z symbols, which are identical or different, correspond to one of the three formulae below:

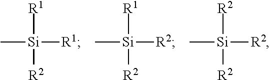

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferentially still a group chosen from C₁-C₄ alkoxyls, in particular methoxyl and ethoxyl).

In the case of a mixture of alkoxysilane polysulfides corresponding to the above formula (I), in particular normal commercially available mixtures, the mean value of the “x” indices is a fractional number preferably of between 2 and 5, more preferentially of approximately 4. However, the invention can also be advantageously implemented, for example, with alkoxysilane disulfides (x=2).

Mention will more particularly be made, as examples of silane polysulfides, of bis((C₁-C₄)alkoxyl(C₁-C₄)alkylsilyl(C₁-C₄)alkyl) polysulfides (in particular disulfides, trisulfides or tetrasulfides), such as, for example, bis(3-trimethoxysilylpropyl) or bis(3-triethoxysilylpropyl) polysulfides. Use is made in particular, among these compounds, of bis(3-triethoxysilylpropyl) tetrasulfide, abbreviated to TESPT, of formula [(C₂H₅O)₃Si (CH₂)₃S₂]₂, or bis(triethoxysilylpropyl) disulfide, abbreviated to TESPD, of formula [(C₂H₅O)₃Si (CH₂)₃S]₂. Mention will also be made, as preferential examples, of bis(mono(C₁-C₄)alkoxyldi(C₁-C₄)alkylsilylpropyl) polysulfides (in particular disulfides, trisulfides or tetrasulfides), more particularly of bis(monoethoxydimethylsilylpropyl) tetrasulfide, such as described in the abovementioned Patent Application WO 02/083782 (or U.S. Pat. No. 7,217,751).

Mention will in particular be made, as examples of coupling agents other than an alkoxysilane polysulfide, of bifunctional POSs (polyorganosiloxanes), or else of hydroxysilane polysulfides (R²═OH in the above formula I), such as described, for example, in patent applications WO 02/30939 (or U.S. Pat. No. 6,774,255), WO 02/31041 (or US 2004/051210) and WO2007/061550, or else of silanes or POSs bearing azodicarbonyl functional groups, such as described, for example, in patent applications WO 2006/125532, WO 2006/125533 and WO 2006/125534.

Mention will be made, as examples of other silane sulfides, for example, of the silanes bearing at least one thiol (—SH) functional group (referred to as mercaptosilanes) and/or at least one masked thiol functional group, such as described, for example, in patents or patent applications U.S. Pat. No. 6,849,754, WO 99/09036, WO 2006/023815 and WO 2007/098080.

Of course, use might also be made of mixtures of the coupling agents described above, as described in particular in the abovementioned application WO 2006/125534.

In the rubber composition in accordance with the invention, the content of the silane coupling agent is adjusted by a person skilled in the art according to the chemical structure of the coupling agent and according to the total specific surface developed by the first silica and the second silica of the rubber composition. It is preferentially within a range extending from 1 to 15 phr, preferentially from 1.5 to 10 phr, more preferentially still from 2 to 5 phr.

The rubber composition in accordance with the invention has as another essential characteristic that of containing a crosslinking system, preferentially a vulcanization system, that is to say a sulfur-based crosslinking system. The sulfur is typically provided in the form of molecular sulfur or of a sulfur-donating agent, preferably in molecular form. Sulfur in molecular form is also referred to under the name molecular sulfur. The term “sulfur donor” is understood to mean any compound which releases sulfur atoms, combined or not combined in the form of a polysulfide chain, which are capable of being inserted into the polysulfide chains formed during the vulcanization and bridging the elastomer chains. Additional to the vulcanization system are various known secondary vulcanization accelerators or vulcanization activators, such as zinc oxide, stearic acid, guanidine derivatives (in particular diphenylguanidine), and the like, incorporated during the first non-productive phase and/or during the productive phase. The sulfur content is preferably between 0.5 and 4 phr and the content of the primary accelerator is preferably between 0.5 and 5 phr. These preferential contents can apply to any one of the embodiments of the invention.

Use may be made, as (primary or secondary) vulcanization accelerator, of any compound capable of acting as accelerator of the vulcanization of diene elastomers in the presence of sulfur, in particular accelerators of the thiazole type, and also their derivatives, accelerators of the sulfenamide type, as regards the primary accelerators, or of the thiuram, dithiocarbamate, dithiophosphate, thiourea and xanthate types, as regards the secondary accelerators. Mention may in particular be made, as examples of primary accelerators, of sulfenamide compounds, such as N-cyclohexyl-2-benzothiazolesulfenamide (“CBS”), N,N-dicyclohexyl-2-benzothiazolesulfenamide (“DCBS”), N-tert-butyl-2-benzothiazolesulfenamide (“TBBS”) and the mixtures of these compounds. The primary accelerator is preferentially a sulfenamide, more preferentially N-cyclohexyl-2-benzothiazolesulfenamide. Mention may in particular be made, as examples of secondary accelerators, of thiuram disulfides, such as tetraethylthiuram disulfide, tetrabutylthiuram disulfide (“TBTD”), tetrabenzylthiuram disulfide (“TBZTD”) and the mixtures of these compounds. The secondary accelerator is preferentially a thiuram disulfide, more preferentially tetrabenzylthiuram disulfide.

The vulcanization is carried out in a known way at a temperature generally of between 130° C. and 200° C., for a sufficient time which can vary, for example, between 5 and 90 min, as a function in particular of the curing temperature, of the vulcanization system adopted and of the kinetics of vulcanization of the composition under consideration.

The rubber composition in accordance with the invention can also comprise all or part of the usual additives customarily used in elastomer compositions intended for the manufacture of tires, in particular pigments, protective agents, such as antiozone waxes, chemical antiozonants or antioxidants, or plasticizers, such as plasticizing oils or resins.

The rubber composition, before vulcanization, can be manufactured in appropriate mixers, using two successive phases of preparation according to a procedure well known to a person skilled in the art: a first phase of thermomechanical working or kneading (sometimes described as a “non-productive” phase) at high temperature, up to a maximum temperature of between 110° C. and 190° C., preferably between 130° C. and 180° C., followed by a second phase of mechanical working (sometimes described as a “productive” phase) at lower temperature, typically of less than 110° C., for example between 40° C. and 100° C., during which finishing phase the sulfur or the sulfur donor and the vulcanization accelerator are incorporated.

By way of example, the first (non-productive) phase is carried out in a single thermomechanical stage during which all the necessary constituents, the optional supplementary processing aids and various other additives, with the exception of the vulcanization system, are introduced into an appropriate mixer, such as an ordinary internal mixer. The total duration of the kneading, in this non-productive phase, is preferably of between 1 and 15 min. After cooling the mixture thus obtained during the first non-productive phase, the vulcanization system is then incorporated at low temperature, generally in an external mixer, such as an open mill; everything is then mixed (productive phase) for a few minutes, for example between 2 and 15 min.

The rubber composition can be calendered or extruded in the form of a sheet or of a plaque, in particular for laboratory characterization, or also in the form of a rubber semi-finished product (or profiled element) which can be used in a tire. The composition can be either in the raw state (before crosslinking or vulcanization) or in the cured state (after vulcanization). It can constitute all or part of a semi-finished article, in particular intended to be used in a pneumatic or non-pneumatic tire which comprises a tread, in particular in the tread of the tire.

To sum up, the invention is advantageously implemented according to any one of the following Embodiments 1 to 25:

Embodiment 1: Rubber composition which comprises a diene elastomer, a first silica which is a precipitated or pyrogenic silica and which has a BET specific surface of greater than 100 m²/g as reinforcing filler, a second silica which is a microsilica with a BET specific surface of less than 50 m²/g, a silane coupling agent and a crosslinking system,

in which:
the contents of the first silica and of the second silica being expressed as part by weight per hundred parts of elastomer, phr, and respectively denoted T1 and T2:
T1 is greater than 15 phr and is less than T2,
and the sum of T1 and of T2 is greater than 75 phr.

Embodiment 2: Rubber composition according to Embodiment 1, in which the second silica has a BET specific surface of greater than 10 m²/g and of less than 40 m²/g.

Embodiment 3: Rubber composition according to Embodiment 1 or 2, in which the second silica has a BET specific surface of greater than or equal to 15 m²/g and of less than or equal to 30 m²/g.

Embodiment 4: Rubber composition according to any one of Embodiments 1 to 3, in which the first silica has a BET specific surface of less than 200 m²/g.

Embodiment 5: Rubber composition according to any one of Embodiments 1 to 4, in which the first silica has a BET specific surface of less than 180 m²/g.

Embodiment 6: Rubber composition according to any one of Embodiments 1 to 5, in which the diene elastomer is a homopolymer of a 1,3-diene or a copolymer of a 1,3-diene or their mixture.

Embodiment 7: Rubber composition according to any one of Embodiments 1 to 6, in which the diene elastomer is a copolymer of ethylene and of a 1,3-diene and contains more than 50 mol % of ethylene units.

Embodiment 8: Rubber composition according to Embodiment 7, in which the copolymer of ethylene and of a 1,3-diene comprises at least 55 mol % of ethylene units.

Embodiment 9: Rubber composition according to Embodiment 7 or 8, in which the copolymer of ethylene and of a 1,3-diene comprises at least 60 mol % of ethylene units.

Embodiment 10: Rubber composition according to any one of Embodiments 1 to 9, in which the copolymer of ethylene and of a 1,3-diene comprises at least 65 mol % of ethylene units.

Embodiment 11: Rubber composition according to any one of Embodiments 7 to 10, in which the copolymer of ethylene and of a 1,3-diene comprises at most 90 mol % of ethylene units.

Embodiment 12: Rubber composition according to any one of Embodiments 7 to 11, in which the copolymer of ethylene and of a 1,3-diene comprises at most 85 mol % of ethylene units.

Embodiment 13: Rubber composition according to any one of Embodiments 7 to 12, in which the copolymer of ethylene and of a 1,3-diene comprises at most 80 mol % of ethylene units.

Embodiment 14: Rubber composition according to any one of Embodiments 7 to 13, in which the copolymer of ethylene and of a 1,3-diene contains 1,2-cyclohexane units.

Embodiment 15: Rubber composition according to Embodiment 14, in which the copolymer of ethylene and of a 1,3-diene contains less than 15 mol % of 1,2-cyclohexane units.

Embodiment 16: Rubber composition according to any one of Embodiments 7 to 15, in which the content of the copolymer of ethylene and of a 1,3-diene is at least 50 phr.

Embodiment 17: Rubber composition according to any one of Embodiments 6 to 16, in which the 1,3-diene is 1,3-butadiene or a mixture of 1,3-dienes, one of which is 1,3-butadiene.

Embodiment 18: Rubber composition according to any one of Embodiments 1 to 17, in which the copolymer is a statistical copolymer.

Embodiment 19: Rubber composition according to any one of Embodiments 1 to 18, in which the sum of T1 and of T2 is between 75 phr and 180 phr.

Embodiment 20: Rubber composition according to any one of Embodiments 1 to 19, in which the sum of T1 and of T2 is less than 140 phr.

Embodiment 21: Rubber composition according to any one of Embodiments 1 to 20, in which the sum of T1 and of T2 is greater than 90 phr and less than 140 phr.

Embodiment 22: Rubber composition according to any one of Embodiments 1 to 21, in which T1 and T2 satisfy the following relationship (1):

$$T 2 \geq 1.73 \times ( T 1 + T 2 ) - 125 \qquad ( 1 )$$

Embodiment 23: Rubber composition according to any one of Embodiments 1 to 22, in which the crosslinking system is a vulcanization system.

Embodiment 24: Tire which comprises a rubber composition according to any one of Embodiments 1 to 23.

Embodiment 25: Tire which comprises a tread comprising a rubber composition according to any one of Embodiments 1 to 24.

A better understanding of the abovementioned characteristics of the present invention, and also of others, will be obtained on reading the following description of several implementational examples of the invention, which are given by way of illustration and without limitation.

### EXAMPLES

### Microstructure of the Elastomers by Nuclear Magnetic Resonance (NMR) Analysis:

The microstructure of the elastomers is determined by ¹H NMR analysis, replaced by 13C NMR analysis when the resolution of the ¹H NMR spectra does not make possible the assignment and the quantification of all the entities. The measurements are carried out using a Bruker 500 MHz NMR spectrometer at frequencies of 500.43 MHz for the observation of the protons and 125.83 MHz for the observation of the carbons.

For the elastomers which are insoluble but which have the ability to swell in a solvent, an HRMAS 4 mm z-grad probe, which makes it possible to observe the protons and the carbons in proton-decoupled mode, is used. The spectra are acquired at spin speeds of 4000 Hz to 5000 Hz.

For the measurements on soluble elastomers, a liquid NMR probe, which makes it possible to observe the protons and the carbons in proton-decoupled mode, is used.

The insoluble samples are prepared in rotors filled with the material analysed and a deuterated solvent which makes swelling possible, in general deuterated chloroform (CDCl₃). The solvent used must always be deuterated and its chemical nature can be adapted by a person skilled in the art. The amounts of material used are adjusted so as to obtain spectra with a sufficient sensitivity and resolution.

The soluble samples are dissolved in a deuterated solvent (approximately 25 mg of elastomer in 1 ml), in general deuterated chloroform (CDCl₃). The solvent or solvent blend used must always be deuterated and its chemical nature can be adapted by a person skilled in the art.

In both cases (soluble sample or swollen sample):

For proton NMR, a simple 30° pulse sequence is used. The spectral window is adjusted in order to observe all of the resonance lines belonging to the molecules analysed. The accumulation number is adjusted in order to obtain a signal to noise ratio which is sufficient for the quantification of each unit. The recycle delay between each pulse is adapted in order to obtain a quantitative measurement.

For carbon NMR, a simple 30° pulse sequence is used with proton decoupling only during the acquisition in order to avoid the “nuclear Overhauser” effects (NOE) and to remain quantitative. The spectral window is adjusted in order to observe all of the resonance lines belonging to the molecules analysed. The accumulation number is adjusted in order to obtain a signal to noise ratio which is sufficient for the quantification of each unit. The recycle delay between each pulse is adapted in order to obtain a quantitative measurement.

The NMR measurements are carried out at 25° C.

### Glass Transition Temperature of the Polymers:

The glass transition temperature (Tg) is measured by means of a differential scanning calorimeter according to Standard ASTM D3418 (1999).

### Mooney Viscosity:

The Mooney viscosity is measured using an oscillating consistometer as described in Standard ASTM D1646 (1999). The measurement is carried out according to the following principle: the sample, analysed in the raw state (i.e., before curing), is moulded (shaped) in a cylindrical chamber heated to a given temperature (100° C.). After preheating for 1 minute, the rotor rotates within the test specimen at 2 revolutions/minute and the working torque for maintaining this movement is measured after rotating for 4 minutes. The Mooney viscosity (ML) is expressed in “Mooney unit” (MU, with 1 MU=0.83 newton.metre).

### Dynamic Properties:

The dynamic properties are measured on a viscosity analyser (Metravib VA4000) according to Standard ASTM D 5992-96.

The response of a sample of vulcanized composition (cylindrical test specimen with a thickness of 4 mm and with a cross section of 400 mm²), subjected to a simple alternating sinusoidal shear stress, at a frequency of 10 Hz, during a temperature sweep, under a stationary stress of 0.7 MPa, is recorded; the tan δ value observed at 0° C. (tan δ at 0° C.) is recorded.

For the measurement of tan delta max at 23° C., a strain amplitude sweep is carried out from 0% to 50% (outward cycle) and then from 50% to 0% (return cycle). For the return cycle, the maximum value of tan δ observed, tan δ (max), is measured.

The results are expressed in base 100, with respect to a control. A value greater than that of the control, arbitrarily set at 100, indicates a measured quantity greater than that of the control.

For tan δ at 0° C., a value of greater than 100 indicates a hysteresis potential greater than that of the control in the area of the performance of the wet grip, i.e. an improved performance of the wet grip.

For tan δ (max) at 23° C., a value of less than 100 indicates poorer hysteresis properties than those of the control in the area of the performance of the rolling resistance, i.e. an improved performance of the rolling resistance.

### Preparation of the Rubber Compositions

Four Rubber Compositions C1 to C4 are Prepared. These Compositions are Manufactured In the Following Way:

The elastomer, then the precipitated silica, if appropriate the microsilica, the silane coupling agent and also the various other ingredients, with the exception of the vulcanization system, are introduced into an internal mixer (final degree of filling: approximately 70% by volume), the initial vessel temperature of which is approximately 80° C. Thermomechanical working (non-productive phase) is then carried out in one stage, which lasts approximately 5 min to 6 min, until a maximum “dropping” temperature of 160° C. is reached. The mixture thus obtained is recovered and cooled and then sulfur and an accelerator of sulfenamide type are incorporated on a mixer (homofinisher) at approximately 60° C., everything being mixed (productive phase) for an appropriate time (for example between 5 and 12 min).

The breakdown of the formulations of the compositions appears in Table 1. The silane content and the DPG content are linked to the total surface area developed by the silicas. The total content of sulfur, which originates from the molecular sulfur (S₈) and from the silane polysulfide, is identical in all the compositions.

The compositions C₂, C₃ and C₄ are compositions in accordance with the invention. They differ from the composition C₁ by the presence of a microsilica. In the compositions according to the invention, the microsilica is used at a higher content than the precipitated silica in order to partially replace it in comparison with the composition C₁.

The compositions thus obtained are subsequently calendered, either in the form of plaques (with a thickness ranging from 2 to 3 mm) or thin sheets of rubber, for the measurement of their physical or mechanical properties after vulcanization at 150° C. (cured state), or in the form of profiled elements which can be used directly, after cutting and/or assembling to the desired dimensions, for example as semi-finished products for tires.

The copolymer of ethylene and of 1,3-butadiene, elastomer E1, is synthesized according to the procedure described below.

All the reactants are obtained commercially except for the metallocene, which can be prepared according to the procedure described in the document WO 2007054224. The butyloctylmagnesium BOMAG (20% in heptane, C=0.88 mol·I⁻¹) originates from Chemtura and is transferred into and then stored in a Schlenk tube under an inert atmosphere. The ethylene, of N35 grade, originates from Air Liquide and is used without prior purification.

13.6 mmol of a 0.01 mol/l solution of butyloctylmagnesium (BOMAG) in methylcyclohexane, a part of which is used to neutralize the impurities in the reactor, then 745 ml of a solution of a catalytic system (see Table 2), the [active Mg]/[Nd] ratio being 4.8, are added to a 90 | reactor containing, at 80° C., 64 | of methylcyclohexane, and also ethylene (Et) and butadiene (Bd) at a molar ratio of 80% of ethylene and of 20% of butadiene. At this moment, the reaction temperature is regulated at 80° C. and the polymerization reaction starts. The polymerization reaction takes place at a constant pressure of 8 bar. The reactor is fed throughout the polymerization with ethylene and with butadiene (Bd) at a molar ratio of 80% of ethylene and of 20% of butadiene. After formation of 6500 g of polymer, the polymerization reaction is halted by cooling, degassing of the reactor and addition of ethanol. An antioxidant is added to the polymer solution. The copolymer is recovered by a steam distillation process known as “stripping” well known to a person skilled in the art and then dried until a content of volatile matter of less than 0.8% by weight is obtained. The catalytic system is a preformed catalytic system. It is prepared in methylcyclohexane starting from a metallocene, [Me₂SiFlu₂Nd(μ-BH₄)₂Li(THF)], from a cocatalyst, butyloctylmagnesium (BOMAG), and from a preformation monomer, 1,3-butadiene, in the contents shown in Table 2. It is prepared according to a preparation method in accordance with section II.1 of patent application WO 2017/093654 A1.

The microstructure of the copolymer E1 and its properties appear in Tables 3 and 4. For the microstructure, Table 3 shows the molar contents of the ethylene (Et) units, of the 1,3-butadiene units and of the 1,2-cyclohexanediyl (ring) units.

As the tan δ at 0° C. value of the compositions C2, C3 and C4 is higher than that of the composition C1, the rubber compositions C2 to C4 have a hysteresis potential in the area of the wet grip performance which is greater than that of the composition C1. This result is obtained even though the content of the precipitated silica conventionally used in tire rubber compositions is much lower than the content of the precipitated silica of the composition C1 representative of the conventional rubber compositions of tire treads.

From the comparison of the compositions C2 to C4 with the composition C1, it is observed, surprisingly, that the addition, to a rubber composition comprising a precipitated silica, of a microsilica at a higher content than the precipitated silica in order to partially replace it makes it possible to increase the hysteresis potential of the rubber composition in the area of wet grip performance.

The compositions C2 and C4 in which the silica contents satisfy the relationship (1) are compositions which also exhibit the best compromise in performance between the wet grip and the rolling resistance, since they also each exhibit a tan delta max at 23° C. value which proves to be among the lowest.

TABLE 1

| Composition | C1 | C2 | C3 | C4 |
|---|---|---|---|---|
| Elastomer E1 | 100 | 100 | 100 | 100 |
| Carbon black (1) | 3 | 3 | 3 | 3 |
| Precipitated silica (2) | 76 | 37.5 | 37.5 | 19 |
| Microsilica (3) | 0 | 76 | 123 | 114 |
| Silane coupling agent (4) | 6.1 | 3.9 | 4.5 | 2.9 |
| DPG (5) | 1.5 | 1.0 | 1.1 | 0.7 |
| Liquid plasticizing agent (6) | 22 | 22 | 22 | 22 |
| Plasticizing resin (7) | 50 | 50 | 50 | 50 |
| Antiozonant wax (8) | 1.6 | 1.6 | 1.6 | 1.6 |
| Antioxidant (9) | 2 | 2 | 2 | 2 |
| ZnO (10) | 0.9 | 0.9 | 0.9 | 0.9 |
| Stearic acid (11) | 2 | 2 | 2 | 2 |
| Sulfur | 1.0 | 1.2 | 1.2 | 1.3 |
| CBS (12) | 2 | 2 | 2 | |
| Tan δ 0° C. | 100 | 106 | 112 | 110 |
| Tan δ max 23° C. | 100 | 100 | 117 | 88 |

(1) N234
(2) Zeosil 1165 MP from Solvay-Rhodia in the form of microbeads, BET of 160 m²/g
(3) Microfume Concrete Premium (92% to 96% of SiO₂) from Ferropem-Montricher, BET of 24 m²/g
(4) TESPT (Si69 from Evonik)
(5) Diphenylguanidine
(6) MES/HPD (Catenex SNR from Shell)
(7) C₉/Dicyclopentadiene hydrocarbon resin, Escorez 5600, from Exxon (Tg=55° C.)
(8) Antiozone wax, Redezon 500, from Repsol
(9) N-(1,3-Dimethylbutyl)-N′-phenyl-para-phenylenediamine (Santoflex 6-PPD from Flexsys)
(10) Zinc oxide, industrial grade, from Umicore
(11) Stearin, Pristerene 4931, from Uniqema
(12) N-Cyclohexyl-2-benzothiazolesulfenamide (Santocure CBS from Flexsys)

TABLE 2

| Synthesis of the catalytic system | |
|---|---|
| Metallocene concentration (mmol/l) | 6.5 |
| Alkylating agent concentration (mmol/l) | 14 |
| Butadiene/Nd metal molar ratio | 90 |

TABLE 3

| Elastomer | E1 |
|---|---|
| Ethylene (mol %) | 77 |
| 1,3-Butadiene (mol %) | 15 |
| 1,2-Cyclohexanediyl (mol %) | 8 |

TABLE 4

| Elastomer | E1 |
|---|---|
| Tg (° C.) | −40° C. |
| Mn (g/mol) | 142 000 |
| Mooney (ML (1 + 4)) at 100° C. | 85 ± 8 |

What is claimed is:

1. A rubber composition which comprises a diene elastomer, a first silica which is a precipitated or pyrogenic silica and which has a BET specific surface of greater than 100 m²/g as reinforcing filler, a second silica which is a microsilica with a BET specific surface of less than 50 m²/g, a silane coupling agent and a crosslinking system,
in which:
the contents of the first silica and of the second silica being expressed as part by weight per hundred parts of elastomer, phr, and respectively denoted T1 and T2:
T1 is greater than 15 phr and is less than T2,
and the sum of T1 and of T2 is greater than 75 phr.

2. The rubber composition according to claim 1, in which the second silica has a BET specific surface of greater than 10 m²/g and of less than 40 m²/g.

3. The rubber composition according to claim 1, in which the first silica has a BET specific surface of less than 200 m²/g.

4. The rubber composition according to claim 1, in which the diene elastomer is a homopolymer of a 1,3-diene or a copolymer of a 1,3-diene or their mixture.

5. The rubber composition according to claim 1, in which the diene elastomer is a copolymer of ethylene and of a 1,3-diene and contains more than 50 mol % of ethylene units.

6. The rubber composition according to claim 4, in which the 1,3-diene is 1,3-butadiene or a mixture of 1,3-dienes, one of which is 1,3-butadiene.

7. The rubber composition according to claim 1, in which the sum of T1 and of T2 is less than 140 phr.

8. The rubber composition according to claim 1, in which the sum of T1 and of T2 is greater than 90 phr and less than 140 phr.

9. The rubber composition according to claim 1, in which T1 and T2 satisfy the following relationship (1):
$$T 2 \geq 1.73 \times ( T 1 + T 2 ) - 125 \qquad ( 1 )$$

10. The rubber composition according to claim 1, in which the crosslinking system is a vulcanization system.

11. A tire which comprises a rubber composition according to claim 1.

12. A tire which comprises a tread comprising a rubber composition according to claim 1.

13. The rubber composition according to claim 3, in which the BET specific surface of the first silica is less than 180 m²/g.
